(19) United States
(12) Patent Application Publication
(10) Pub. No.: US 2006/0045174 A1
(43) Pub. Date: Mar. 2, 2006

(54) Method and apparatus for synchronizing a transmitter clock of an analog modem to a remote clock

(75) Inventors: Vikram Phogat, Bangalore (IN); Narasimha Pai, Bangalore (IN)

Correspondence Address: DILLON & YUDELL LLP, 8911 NORTH CAPITAL OF TEXAS HWY, SUITE 2110, AUSTIN, TX, 78759, US

(73) Assignees: ITTIAM SYSTEMS (P) LTD.; SILICON LABORATORIES, INC.

(21) Appl. No.: 10/930,210

(22) Filed: Aug. 31, 2004

(51) Int. Cl. H04L 5/16

(52) U.S. Cl. 375/222; 375/354

(57) ABSTRACT

A method and apparatus for synchronizing a transmitter clock of an analog modem to a codec sampling clock within a central office are provided. The analog modem includes a transmitter, a receiver and a codec. The analog modem also includes a transmitter re-sampler and a receiver re-sampler coupled to the transmitter and the receiver, respectively. Transmitter signals provided to the codec in a transmit path of the analog modem are re-sampled. The sampling rate of the transmitter re-sampler is subsequently derived from a re-sampling period of the receiver re-sampler provided between the receiver and the codec. The transmitter clock of the analog modem is then synchronized with the codec sampling clock in the central office.

The present patent application is related to a copending application U.S. Ser. No. ______, filed on even date, entitled “METHOD AND APPARATUS FOR IMPROVING UPSTREAM PULSE CODE MODULATION CONNECT RATES OF AN ANALOG MODEM” (Attorney Docket No. SILA0014), the pertinent of which is hereby incorporated herein by reference.

### BACKGROUND OF THE INVENTION

1. Technical Field

The present invention relates to data communications in general, and in particular to data communications utilizing modems. Still more particularly, the present invention relates to a method and apparatus for synchronizing a transmitter clock of an analog modem to a remote receiver clock.

2. Description of Related Art

Voice band modems are commonly used to transmit data over telephone lines. Conventional voice band modems are designed to use a public switched telephone network (PSTN) as an analog communication channel. However, modern PSTNs typically utilize digital links to connect to server modems. Thus, most of the server modems are connected to the PSTN via digital links, and only client modem connections to the PSTN are made via analog subscriber lines.

According to the International Telecommunication Union (ITU), voice band modems are designated as “V.” series of modems. Pulse code modulated (PCM) modems, such as ITU-T V.90 and V.92 modems, can take advantage of the digital portion of the PSTN and use PCM transmissions to obtain relatively high data rates. V.90 and V.92 server modems are connected to the digital portion of a PSTN, and hence are called digital modems. V.90 and V.92 client modems are connected to the analog portion of a PSTN, and hence are called analog modems.

V.90 modems support data rates up to 56 kbps in downstream transmissions, which are server-to-client transmissions, and 33.6 kbps in upstream transmissions, which are client-to-server transmissions. V.90 modems use PCM transmissions for downstream transmissions and quadrature amplitude modulated (QAM) transmissions for upstream transmissions.

During V.90 downstream transmissions from a digital modem to an analog modem, the digital modem transmits 8-bit words that correspond to the different levels of a central office (CO) codec output. In turn, the CO codec converts the eight bit words into analog voltage levels on an analog subscriber line. An analog modem samples the analog voltage levels on the analog subscriber line, equalizes the voltage levels to remove the distortions caused by the analog channel, and then maps the voltage levels back to the originally transmitted eight bit words. PCM transmission is possible in the downstream direction because there is no quantization loss at the CO. PCM transmissions are not possible when there is an analog link between two COs.

ITU-T V.92 modem standard is an enhancement to the ITU-T V.90 modem standard for V.90 modems. V.92 modems are capable of using PCM transmissions for both upstream and downstream transmissions. Downstream transmissions for V.92 modems are basically the same as V.90 modems. For upstream transmissions, a V.92 analog modem transmits a set of analog voltage levels on an analog subscriber line, which is then modified by an analog channel. The CO codec samples the voltage levels and converts them into eight bit words. V.92 modems can support data rates up to 48 kbps in upstream transmissions. In order to take full advantage of the digital link for achieving the best performance in upstream transmissions, quantization losses at the CO codec should be minimized. As such, the analog voltage levels received at the sampling instant of the CO codec should be very close to the fixed sampling levels of the CO codec.

### SUMMARY OF THE INVENTION

In order to allow analog voltage levels received at the sampling instant of a central office (CO) codec to be very close to the fixed sampling levels of the CO codec, an analog modem needs to pre-equalize its transmit channel at its transmitter and synchronize its transmitter clock to the sampling clock of the CO codec. The present invention provides a method and apparatus for synchronizing the transmitter clock of an analog modem to the sampling clock of a CO codec.

In accordance with a preferred embodiment of the present invention, an analog modem includes a modem transmitter, a modem receiver and a modem codec. The analog modem also includes a transmitter re-sampler and a receiver re-sampler coupled to the modem transmitter and the modem receiver, respectively. Transmitter signals provided to the modem codec in a transmit path of the analog modem are re-sampled. The sampling rate of the transmitter re-sampler is subsequently derived from a re-sampling period of the receiver re-sampler located between the modem receiver and the modem codec, thereby achieving synchronization between the codec sampling clock in the central office and the analog modem transmitter clock.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a public switched telephone network environment to which a preferred embodiment of the present invention is applicable; and

FIG. 2 is a detailed block diagram of various components within the public switched telephone network from FIG. 1, in accordance with a preferred embodiment of the present invention.

### DETAILED DESCRIPTION OF A PREFERRED EMBODIMENT

The present invention provides a method and apparatus for synchronizing a transmitter clock of a transmitter in a V.92 analog modem to a sampling clock of a codec in a central office (CO) within a public switched telephone network (PSTN). Such synchronization is a prerequisite for providing the V.92 analog modem with a pulse code modulated (PCM) transmission capability in an upstream direction.

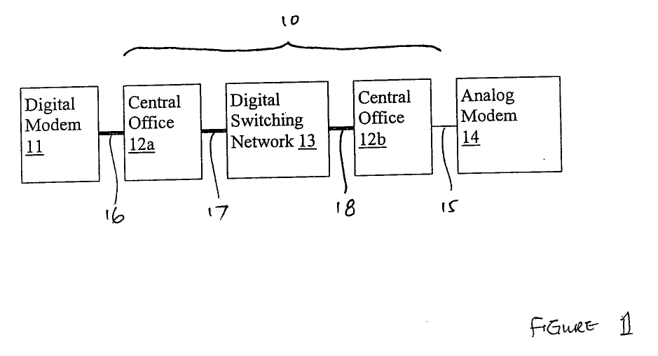

Referring now to the drawings and in particular to FIG. 1, there is depicted a block diagram of a PTSN in which a preferred embodiment of the present invention is incorporated. As shown, a digital modem 11 is connected to a CO 12a of a PSTN 10 via a digital link 16. CO 12a is connected to a digital switching network 13 via a digital link 17. A CO 12b is also connected to digital switching network 13 via a digital link 18. An analog modem 14 is connected to CO 12b through an analog channel 15. Analog channel 15, which corresponds to an individual analog subscriber line, is the only analog link within PSTN 10. Thus, PTSN 10 preferably includes:
i. digital modems connected to central offices via digital links;
ii. analog modems connected to central offices via analog links; and
iii. a digital switching network.
   Digital modem 11, which is preferably used at an Internet service provider location, can be referred to as a server modem. Analog modem 14, which is preferably used at an end user terminal, can be referred to as a client modem.

In accordance with a preferred embodiment of the present invention, in order to provide transmitter clock synchronizations, a transmitter re-sampler is inserted in a transmit path of analog modem 14 between a modem transmitter and a modem codec. Similarly, a receiver re-sampler is inserted in a receive path of analog modem 14 between a modem receiver and the modem codec. The transmitter re-sampler and receiver re-sampler receive inputs from a clock recovery module.

Some of the variables used in the present disclosure along with their respective definitions are given below:
F_{S}—symbol rate of an analog modem receiver and transmitter
F_{C}—sampling rate of an analog modem codec
F_{STX}—default sampling rate of an analog modem transmitter
F_{SRX}—default sampling rate of an analog modem receiver
F_{SRX}+ΔF_{SRX}—estimated receiver sampling rate used by an analog modem receiver to synchronize its clock to a CO codec clock
F_{STX}+ΔF_{STX}—estimated transmitter sampling rate used by an analog modem transmitter to synchronize its clock to a CO codec clock

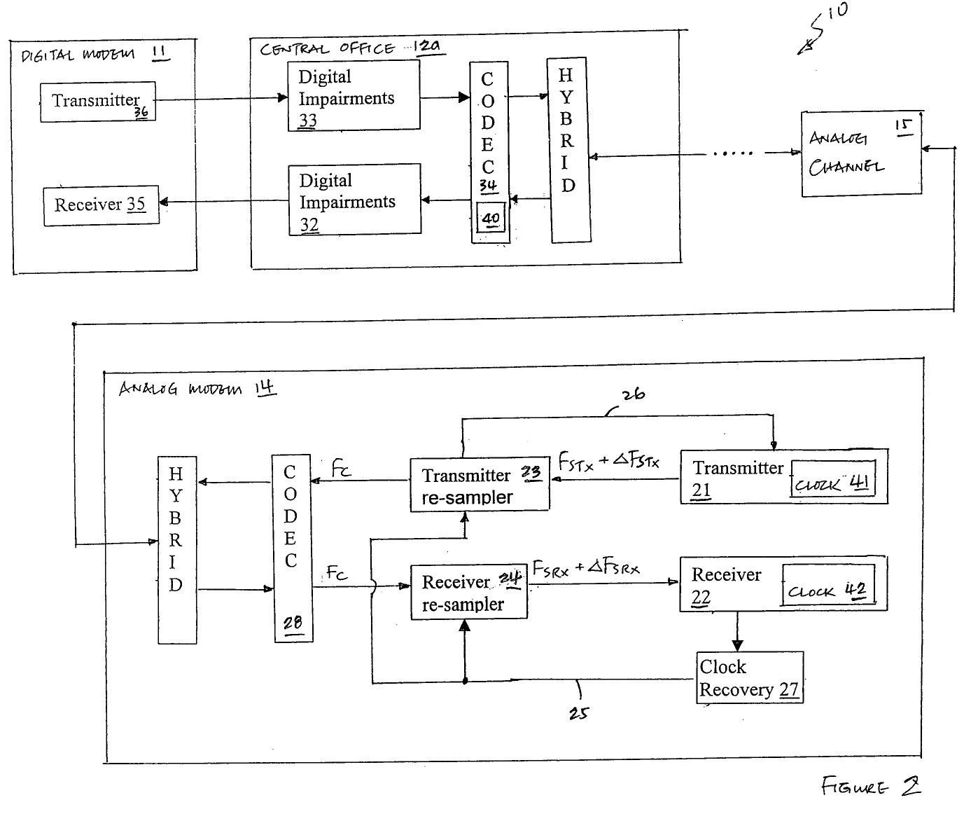

With reference now to FIG. 2, there is depicted a detailed block diagram of various components within public switched telephone network 10 from FIG. 1, in accordance with a preferred embodiment of the present invention. As shown, analog modem 14 is connected to digital modem 11 through analog channel 15 and CO 12a. Analog modem 14 includes a V.92 analog modem transmitter 21 and a V.92 analog modem receiver 22 for performing PCM transmissions in both upstream and downstream directions (i.e., transmitting and receiving, respectively). Analog modem 14 can transmit linear PCM samples in an upstream direction. PCM transmissions in the upstream direction are made possible by synchronizing a transmitter clock 41 within modem transmitter 21 to a clock 40 within CO 12a. V.92 analog modem receiver 22 is quite similar to a V.90 analog modem receiver. However, V.92 analog modem transmitter 21 is very different from a V.90 analog modem transmitter. Modem transmitter 21 transmits pulse-amplitude modulated (PAM) signals and synchronizes its samples with clock 40 in CO 12a. In contrast, a V.90 analog modem transmitter transmits quadrature-amplitude modulated (QAM) signals and does not perform any clock synchronization.

For downstream data receptions, modem receiver 22 synchronizes a receiver clock 42 with clock 40 in CO 12a using a clock estimate 25 generated by a clock recovery module 27. A receiver re-sampler 24 uses clock estimate 25 to re-sample the received samples at a rate proportionate to clock 40 in CO 12a. Clock estimate 25 is also used by modem transmitter 21 to synchronize transmitter clock 41 to clock 40 in CO 12a.

Digital modem 11 includes a transmitter 36 and a receiver 35. Receiver 35 estimates an initial phase error between analog modem transmit clock 41 and clock 40 in CO 12a during the V.92 handshake procedure. Such estimate of the initial phase error is transmitted back to analog modem 14, and transmitter re-sampler 23 corrects the initial phase error during the V.92 handshake procedure. After the initial phase error has been corrected, modem transmitter 21 starts deriving transmitter clock 41 from modem receiver 22.

Analog modem 14 includes a modem codec 28 that operates at a rate higher than a symbol rate F_{S} used in modem transmitter 21 and modem receiver 22. Transmitter re-sampler 23 and receiver re-sampler 24 synchronize transmitter clock 41 and receiver clock 42, respectively, to clock 40 in CO 12a. Transmitter re-sampler 23 and receiver re-sampler 24 are preferred implemented as sync interpolators where re-samplings are performed by interpolations and decimations.

The basic difference between receiver re-sampler 24 and transmitter re-sampler 23 is that, for receiver re-sampler 24, the input sampling frequency F_{C} is fixed while the output sampling frequency F_{SRX}+ΔF_{SRX} varies, and for transmitter re-sampler 23, the input sampling frequency F_{STX}+ΔF_{STX} varies while the output sampling frequency F_{C} is fixed. To ensure that modem codec 28 always has samples to transmit at its sampling instant, transmitter re-sampler 23 controls the transmitter-processing rate using a control path 26. Control path 26 also ensures that modem transmitter 21 is transmitting symbols at a rate equal to the estimated CO codec sampling rate, i.e., F_{STX}+ΔF_{STX}.

The sampling rate F_{C} of modem codec 28 is greater than the symbol rate F_{S} of modem transmitter 21 and modem receiver 22, i.e., F_{C}>F_{S}. The sampling rate F_{SRX} at which modem receiver 22 receives samples from receiver re-sampler 24 is greater than the symbol rate F_{S} of modem receiver 22, i.e., F_{SRX}>F_{S}. When analog modem 14 is using PCM transmissions in the upstream direction as in case of a V.92 analog modem, then the sampling rate F_{STX} of modem transmitter 21 is equal to the symbol rate F_{S} of modem transmitter 21, i.e., F_{STX}=F_{S}.

Receiver re-sampler 24 accepts input samples from CO 12a at the sampling rate F_{C} of modem codec 28. These samples are converted to the default sampling rate F_{SRX} of modem receiver 22 when modem receiver 22 has not yet estimated the period of clock 40 within CO 12a. The default period of receiver re-sampler 24 is obtained by combining its interpolation factor with the ratio of the sampling rate of modem codec 28 to the sampling rate of modem receiver 22, i.e., default re-sampling period of receiver re-sampler 24, as follows:

$$\begin{matrix}\begin{matrix} & {T}_{A} = {I}_{P} * {F}_{C} \text{/} {F}_{SRX}\end{matrix} & \\ \begin{matrix}⇒ & {T}_{A} = {C}_{1} \text{/} {F}_{SRX}\end{matrix} & ( 1 )\end{matrix}$$

where I_{P} is the interpolation factor of receiver re-sampler 24 and C₁=I_{P}*F_{C}. The value of I_{P} is assumed to be one because it will not have any effect on the final equation of the period of transmitter clock 41. Clock recovery module 27 then changes the re-sampling period of receiver re-sampler 24 from its default value T_{A} to a value T_{A}+ΔT_{A} such that

$$\begin{matrix}\begin{matrix} & {T}_{A} + Δ {T}_{A} = {C}_{1} \text{/} ( {F}_{SRX} + Δ {F}_{SRX} )\end{matrix} & \\ \begin{matrix}⇒ & Δ {F}_{SRX} = - Δ {T}_{A} * {F}_{SRX} \text{/} ( {T}_{A} + Δ {T}_{A} )\end{matrix} & ( 2 )\end{matrix}$$

where ΔF_{SRX} is the relative clock frequency difference between analog modem 14 and clock 40 within CO 12a learned by clock recovery module 27 of analog modem 14. ΔT_{A} is the corresponding change in the re-sampling period.

Transmitter re-sampler 23 has a fixed output sampling rate of F_{C} and a variable input sampling rate. The default input sampling rate is F_{STX}. The default re-sampling period for transmitter re-sampler 23 can be determined by

$$\begin{matrix}\begin{matrix} & {T}_{B} = {I}_{P} * {F}_{STX} \text{/} {F}_{C}\end{matrix} & \\ \begin{matrix}⇒ & {T}_{B} = {C}_{2} * {F}_{STX}\end{matrix} & ( 3 )\end{matrix}$$

where I_{P} is the interpolation factor of transmitter re-sampler 23 and C₂=I_{P}/F_{C}.

In order to minimize the quantization loss at CO codec 34 within CO 12a, analog modem 14 needs to remove the phase offset between its sampling clock and CO codec sampling clock, and in addition, analog modem 14 needs to transmit symbols at the sampling rate of CO codec 34. Thus, during the V.92 handshake procedure, receiver 35 within digital modem 11 estimates the phase offset between CO codec 34's receive sampling instant and modem codec 28's transmit sampling instant. Such phase offset information are then transferred to analog modem 14. Analog modem 14 then corrects the phase offset in modem transmitter 21.

After the phase correction, analog modem 14 synchronizes the symbol rate of modem transmitter 21 to the sampling rate of CO codec 34. In order to perform such synchronization, transmitter re-sampler 23 changes the sampling rate of modem transmitter 21 from the default value F_{STX} to F_{STX}+ΔF_{STX}. Because the input sampling rate of transmitter re-sampler 23 has changed but the output sampling rate remains F_{C}, analog modem 14 changes the re-sampling period of transmitter re-sampler 23 from its default value such that

$$\begin{matrix}\begin{matrix} & {T}_{B} + Δ {T}_{B} = {C}_{2} * ( {F}_{STX} + Δ {F}_{STX} )\end{matrix} & \\ \begin{matrix}⇒ & Δ {T}_{B} = {C}_{2} * Δ {F}_{STX}\end{matrix} & ( 4 )\end{matrix}$$

where ΔF_{STX} is the relative clock frequency difference between analog modem 14 and CO codec 34 learned by clock recovery module 27 of analog modem 14, and ΔT_{B} is the corresponding change in the re-sampling period.

CO codec 34 uses a single clock, i.e., clock 40, to sample signals in both transmit and receive directions. The same is true for modem codec 28 within analog modem 14. Hence,

$$\begin{matrix} ( {F}_{STX} + Δ {F}_{STX} ) / {F}_{STX} = ( {F}_{SRX} + Δ {F}_{SRX} ) \text{/} {F}_{SRX} & \\ ⇒ Δ {F}_{STX} = Δ {F}_{SRX} * ( {F}_{STX} \text{/} {F}_{SRX} ) & \\ ⇒ Δ {F}_{STX} = {C}_{3} * Δ {F}_{SRX} & ( 5 )\end{matrix}$$

where C₃=F_{STX}/F_{SRX}. Using the above-mentioned equations, the change in the re-sampling period becomes
ΔT_{B}=−C₂*C₃*F_{SRX}*ΔT_{A}/(T_{A}+ΔT_{A}) (6)
Using equation (6), transmit clock information can be derived from the receiver clock estimates. Equation (6) involves a division but an approximation can be used to avoid a division operation. Accuracy of the clocks used in CO codec 34 and analog modem 14 front end is in the order of 50 ppm, hence

$$\vert Δ {F}_{SRX} \vert « {F}_{SRX} or \vert Δ {T}_{A} \vert « {T}_{A} \\ ⇒ {T}_{A} + Δ {T}_{A} ≃ {T}_{A}$$

Thus,

$$Δ {T}_{B} ≃ - {C}_{2} * {C}_{3} * {F}_{SRX} * Δ {T}_{A} \text{/} ( {T}_{A} ) \\ ⇒ Δ {T}_{B} ≃ C * Δ {T}_{A}$$

where C=−(F_{SRX}*F_{STX})/(F_{C}*F_{C}). Such approximation works quite well for a V.92 analog modem such as analog modem 14. Hence, the change in the transmitter clock period can be determined by multiplying the change in the receiver clock period by a constant. The above-described method is based on the assumption that the clock recovery algorithm of modem receiver 22 will estimate the frequency offset between clock 40 within CO codec 34 and receiver clock 42 within modem receiver 22 accurately.

As has been described, the present invention provides a method and apparatus for synchronizing a transmitter clock within an analog modem to a clock within a CO. There are certain requirements for the smooth and accurate working of the method of the present invention. The precision of variables used in the receiver clock recovery algorithm should be sufficiently high. A precision of the order of 48 bits is ideal for the “time period” and “accumulated clock phase” of a phase-locked loop in a clock recovery module, such as clock recovery module 27. Receiver clock recovery scheme continuously updates its clock “time period” to track the clock frequency drifts that occur over a long time. The transmitter of the analog modem derives its re-sampler time-period by taking an average of the time-period of the modem receiver over a large number of symbols. This minimizes the instantaneous phase drift in transmitter samples.

In addition, in V.92 modulations, during Rate Renegotiation with Silence (RRNG), the server modem transmits silence for a short period. During this silence period, the clock recovery module of the modem receiver will not update the re-sampler time-period. Hence, the accurately estimated averaged “time period” is particularly useful during the silence period.

It is also important to note that although the present invention has been described in a hardware context, those skilled in the art will appreciate that the method of the present invention are capable of being distributed as a program product in a variety of forms, and that the present invention applies equally regardless of the particular type of signal bearing media utilized to actually carry out the distribution. Examples of signal bearing media include, without limitation, recordable type media such as floppy disks or CD ROMs and transmission type media such as analog or digital communications links.

While the invention has been particularly shown and described with reference to a preferred embodiment, it will be understood by those skilled in the art that various changes in form and detail may be made therein without departing from the spirit and scope of the invention.

What is claimed is:

1. A method for synchronizing a clock within an analog modem to a remote clock within a public switched telephone network, wherein said analog modem includes a modem transmitter, a modem receiver and a modem codec, said method comprising:
utilizing a transmitter re-sampler to re-sample a plurality of transmitter signals from said modem transmitter to said modem codec in a transmit path of said analog modem;
deriving a sampling rate for said transmitter re-sampler from a re-sampling period of a receiver re-sampler provided between said modem receiver and said modem codec; and
synchronizing a transmitter clock within said modem transmitter to a sampling clock within a codec in said central office.

2. The method of claim 1, wherein said transmitter re-sampler re-samples said plurality of transmitter signals via interpolation and decimation.

3. The method of claim 1, wherein said method further includes synchronizing a symbol rate of said modem transmitter to a sampling rate of said codec within said central office after said estimated phase offset correction.

4. A computer program product residing on a computer usable medium for synchronizing a clock within an analog modem to a remote clock within a public switched telephone network, wherein said analog modem includes a modem transmitter, a modem receiver and a modem codec, said computer program product comprising:
program code means for utilizing a transmitter re-sampler to re-sample a plurality of transmitter signals from said modem transmitter to said modem codec in a transmit path of said analog modem;
program code means for deriving a sampling rate for said transmitter re-sampler from a re-sampling period of a receiver re-sampler provided between said modem receiver and said modem codec; and
program code means for synchronizing a transmitter clock within said modem transmitter to a sampling clock within a codec in said central office.

5. The computer program product of claim 4, wherein said transmitter re-sampler re-samples said plurality of transmitter signals via interpolation and decimation.

6. The computer program product of claim 4, wherein said computer program product further includes program code means for synchronizing a symbol rate of said modem transmitter to a sampling rate of said codec within said central office after said estimated phase offset correction.

7. An apparatus for synchronizing a clock within an analog modem to a remote clock within a public switched telephone network, wherein said analog modem includes a modem transmitter, a modem receiver and a modem codec, said apparatus comprising:
a transmitter re-sampler for re-sampling a plurality of transmitter signals from said modem transmitter to said modem codec in a transmit path of said analog modem;
means for deriving a sampling rate for said transmitter re-sampler from a re-sampling period of a receiver re-sampler provided between said modem receiver and said modem codec; and
means for synchronizing a transmitter clock within said modem transmitter to a sampling clock within a codec in said central office.

8. The apparatus of claim 7, wherein said transmitter re-sampler re-samples said plurality of transmitter signals via interpolation and decimation.

9. The apparatus of claim 7, wherein said apparatus further includes means for synchronizing a symbol rate of said modem transmitter to a sampling rate of said codec within said central office after said estimated phase offset correction.
